(19) United States
(12) Patent Application Publication
(10) Pub. No.: US 2016/0348841 A1
(43) Pub. Date: Dec. 1, 2016

(54) HYDROGEN DISPENSING APPARATUS

(71) Applicant: ENERGYOR TECHNOLOGIES INC, Saint-Laurent (CA)

(72) Inventors: Thomas David JONES, Montreal (CA); Michel Meyer BITTON, Saint-Laurent (CA)

(21) Appl. No.: 14/863,497

(22) Filed: Sep. 24, 2015

Related U.S. Application Data
(60) Provisional application No. 62/169,026, filed on Jun. 1, 2015.

(51) Int. Cl. F17C 7/04; F17C 7/02

(52) U.S. Cl. CPC F17C 7/04; F17C 7/02; F17C 2221/012; F17C 2223/0161; F17C 2225/0161; F17C 2227/0157; F17C 2227/0302; F17C 2227/0374; F17C 2265/065; F17C 2270/0189

(57) ABSTRACT

A dispensing apparatus for a cryogenic fuel includes a cryogenic compression tank with an amount of liquid hydrogen in it. The liquid hydrogen is held at a first temperature and first pressure. The compression tank has a liquid hydrogen inlet and a gaseous hydrogen outlet. A heater is mounted in the compression tank for heating the liquid hydrogen therein to a second temperature and a second pressure. The second temperature and pressure are higher than the first temperature and pressure so that the liquid hydrogen is converted to gaseous hydrogen. A closable line is connected to the gaseous hydrogen outlet and extends from it. The closable line is in fluid communication with a receiving tank when the line is opened so that the gaseous hydrogen flows from the compression tank to the receiving tank.

### CROSS-REFERENCE TO RELATED APPLICATIONS

The Applicants hereby claim priority from previously field U.S. provisional application Ser. No. 62/169,026, filing date Jun. 1, 2015, the contents of which are hereby incorporated by reference.

### TECHNICAL FIELD

The present generally concerns liquid hydrogen transportation and more particularly liquid hydrogen transportation followed by dispensing same into a remote tank.

### BACKGROUND

Recently, alternative energy sources, or energy carriers, such as hydrogen have generated considerable interest. Automobiles and other vehicles that use hydrogen as a fuel source have been developed, but methods for refueling these vehicles that can compete with gasoline fueling stations on scale or cost have not yet been developed. Gasoline fueling stations are very simple and typically only consist of tanks for storing the gasoline and one or more pumps. The options that have been developed for hydrogen fueling to date are expensive, too large and require excessive maintenance.

Several designs of hydrogen transportation and dispensing systems are described in the following.

US2011/0041949 to Nikunji Gupta et al for “Hydrogen Dispensing System And Method Thereof” teaches a hydrogen dispensing system comprising: a feed vessel for storing liquid hydrogen having an inlet and an outlet; a flash drum having an inlet and an outlet; a dispenser for dispensing gaseous hydrogen at a pressure of greater than 300 bar, having an inlet and an outlet wherein the feed vessel outlet is in fluid communication with the flash drum inlet, the flash drum outlet is in fluid communication with the dispenser inlet and there is no compression apparatus between the feed vessel outlet and the dispenser outlet. The invention also provides a method of providing gaseous hydrogen to a vehicle.

US 2009/0308083 to Tobias Brunner for “Method for Filling a Pressure Vessel, Provided for a Cryogenic Storage Medium, in particular Hydrogen” teaches a method for filling a cryo-compressed tank of a motor vehicle with a cryogenic storage medium, such as hydrogen, which can be stored in the tank under absolute pressure values in an order of magnitude of 150 bar or more, the hydrogen is taken in the liquid state at a suitable saturation temperature under essentially ambient pressure from a large supply vessel. Following removal from the large supply vessel, the hydrogen is compressed essentially adiabatically with a cryo pump and then is introduced at super critical pressure (13 bar or more) into the cryo-compressed tank. Preferably beforehand it is also re-cooled to approximately 20 K passing it through a heat exchanger, disposed in the hydrogen, stored in the large supply vessel. Before filling with new storage medium, the residual storage medium, contained in the cryo-compressed tank, can be removed from the cryo-compressed tank and introduced into the large supply vessel.

US 2010/0236259 to Tobias Brunner et el for “Operating Method for a Cryo-Compressed Tank” teaches an operating method for a cryo-compressed tank for supplying cryogenic hydrogen to a consumer of a motor vehicle under supercritical pressure at 13 bar or more. In order to compensate for pressure loss resulting from hydrogen removal, the removed hydrogen that has been heated in a heat exchanger is conveyed to a heat exchanger, provided in the cryo-compressed tank, by way of a tank pressure regulating valve and a branch line, which branches off of a supply line leading to the consumer. After flowing through the heat exchanger, it is introduced into the supply line downstream of the branching off of the branch line. Over a period of time that significantly exceeds the cycle times of a conventional frequency valve, either the removed amount of hydrogen is guided without limitation into the heat exchanger, provided in the cryo-compressed tank, the tank pressure regulating valve being completely open, or no return of the heated hydrogen into the heat exchanger occurs at all. Downstream of the branching off of the branch line, the supply line has a pressure regulating unit, which ensures that irrespective of the changes in the pressure in the supply line caused upstream of the pressure regulating unit by switching the tank pressure regulating valve, a sufficient and continuous supply of hydrogen to the consumer at the pressure required is guaranteed.

One system that has been developed provides for storage of gaseous hydrogen at the fueling station and one or more large compressors that are used to raise the pressure of the hydrogen to the pressure required for fueling, typically from 300 to 700 bar. This option has a large footprint due to the size and design of the compressor system as well as high energy usage.

Another system that has been developed provides for storage of liquid hydrogen at the fueling station. The liquid hydrogen is pumped by a cryo-pump to a higher pressure and then it is evaporated to gaseous hydrogen that is used for fueling. Both of these options and the others known to those of ordinary skill in the art require mechanical compression or pumping to raise the pressure of the hydrogen for use in fueling vehicles.

Thus, there is a need for an improved apparatus for transporting and dispensing hydrogen.

### BRIEF SUMMARY

We have designed a low cost, safe method of transporting and delivering hydrogen to a flight tank for use in an unmanned aircraft. Our apparatus can also be modified to deliver hydrogen fuel to automobiles and the like. Also, our apparatus is much simpler, cheaper and requires less space than those currently used. In addition, the maintenance requirements and energy use are reduced thereby making our hydrogen dispensing apparatus a viable alternative to the dispensing systems of the prior art.

Accordingly, there is provided a dispensing apparatus for a cryogenic fuel, the apparatus comprising:

a cryogenic compression tank having therein an amount of liquid hydrogen, the liquid hydrogen being held at a first temperature and first pressure, the compression tank having a liquid hydrogen inlet and a gaseous hydrogen outlet;

a heater mounted in the compression tank for heating the liquid hydrogen therein to a second temperature and a second pressure, the second temperature and pressure being higher than the first temperature and pressure so that the liquid hydrogen is converted to gaseous hydrogen; and

a closable line connected to the gaseous hydrogen outlet and extending therefrom, the closable line being in fluid communication with a receiving tank when the line is opened so that the gaseous hydrogen flows from the compresion tank to the receiving tank.

In one example, the liquid hydrogen inlet is connected to a filling tank. A valve is located in series between the filling tank and the compression tank.

In one example, the closable line includes a pre-heater located in series between the gaseous hydrogen outlet and a receiver tank connector. The first and second valves are located on either side of the pre-heater. A vent is located in series between the first valve and the gaseous hydrogen outlet.

In another example, the receiving tank is located inside an unmanned aircraft.

### BRIEF DESCRIPTION OF THE DRAWINGS

These and other features of that described herein will become more apparent from the following description in which reference is made to the appended drawings wherein:

FIG. 1 is a diagrammatic representation of a hydrogen transporting and dispensing apparatus.

### DETAILED DESCRIPTION

### Definitions

Unless otherwise specified, the following definitions apply:

The singular forms “a”, “an” and “the” include corresponding plural references unless the context clearly dictates otherwise.

As used herein, the term “comprising” is intended to mean that the list of elements following the word “comprising” are required or mandatory but that other elements are optional and may or may not be present.

As used herein, the term “consisting of” is intended to mean including and limited to whatever follows the phrase “consisting of”. Thus, the phrase “consisting of” indicates that the listed elements are required or mandatory and that no other elements may be present.

It is known in the art that hydrogen is a liquid at 20.37 Kelvin (−253 degC). In a closed system, when heat is applied, the liquid hydrogen begins to evaporate. The temperature and pressure rises to the so-called “Critical Point” when viewed on a phase diagram.

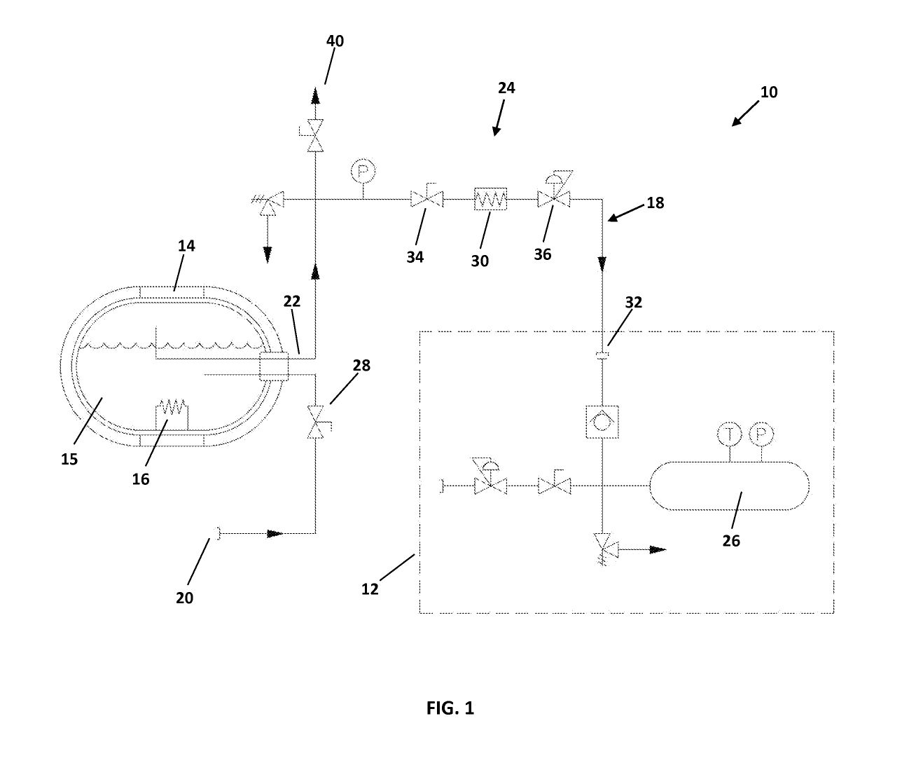

Referring now to FIG. 1, a dispensing apparatus for a cryogenic fuel is shown generally at 10. The dispensing apparatus 10 is shown connected to a flight tank 12. In one example, the flight tank 12 is located inside an unmanned aircraft. Broadly speaking, the dispensing apparatus 10 includes a cryogenic compression tank 14, a heater 16 and a closable line 18. The cryogenic compression tank 14 is filled with an amount of liquid hydrogen 15, which is held at a first temperature and first pressure. The compression tank 14 has a liquid hydrogen inlet 20 and a gaseous hydrogen outlet 22. The liquid hydrogen inlet 20 is connected to a filling tank (not shown). In the example shown, the compression tank 14 is a 5 litre tank. The heater 16 is mounted inside the compression tank 14 for heating the stored liquid hydrogen 15 therein. The heater 16 can be operated externally of the tank 14 to a second temperature and a second pressure, the second temperature and pressure being higher than the first temperature and pressure so that the liquid hydrogen is converted to gaseous hydrogen.

A network 24 which includes the closable line 18 that is connected to the gaseous hydrogen outlet 22 and extends away from it. The closable line 18 is in fluid communication with a receiving tank 26. In this example the receiving tank 26 is located in the flight tank 12, so when the line 18 is opened the gaseous hydrogen flows under pressure from the compression tank 14 to the receiving tank 26.

A valve 28 is located in series between the filling tank (not shown) and the compression tank 14. The closable line 18 includes a pre-heater 30 located in series between the gaseous hydrogen outlet 22 and a receiving tank connector 32.

Power for the electric heaters 16 and 30 is supplied using batteries (not shown) or other electrical power source.

Two valves 34, 36 are located on either side of the pre-heater 30. The valve 36 acts as a pressure regulator for controlling the pressure of the gaseous hydrogen flowing into the receiving tank 26.

A vent 40 is located in series between the first valve 34 and the gaseous hydrogen outlet 22.

The dispensing apparatus 10 can be used either as a transportable apparatus using, for example, a vehicle, or, it can be a hand-held carrying tank for smaller operations requiring less hydrogen.

At the hydrogen filling location, the tank 14 is filled with the liquid hydrogen (LH2) 15. Under Department of Transportation (DOT) or Transport Canada regulations, the liquid hydrogen can be transported to the location of choice. The flight tank 12 is filled with high pressure gaseous hydrogen in the field. Advantageously, this eliminates a heavy gas booster system, a large hydrogen supply tank, and a very large gasoline powered air compressor which are currently used. All of these extra components typically require transportation to the field, which incurs additional expense and effort.

Generally speaking, the apparatus 10 requires about 5 litres of liquid hydrogen to fill a 4 litre tank to 700 bar (10,000 psi). The resulting volume of 9 litres would be at 700 bar at the end when all the liquid hydrogen is evaporated. Afterwards, the 5 litre tank is then bled off, or the hydrogen could be used to power a ground power system for the flight using the cryo compression tank 14.

Advantageously, our apparatus permits the hydrogen pressure to rise up to 700 bar and thereafter the hydrogen is used specifically to fill a separate gaseous hydrogen tank.

### Other Embodiments

From the foregoing description, it will be apparent to one of ordinary skill in the art that variations and modifications may be made to the embodiments described herein to adapt it to various usages and conditions.

What is claimed is:

1. A dispensing apparatus for a cryogenic fuel, the apparatus comprising:
a cryogenic compression tank having therein an amount of liquid hydrogen, the liquid hydrogen being held at a first temperature and first pressure, the compression tank having a liquid hydrogen inlet and a gaseous hydrogen outlet;
a heater mounted in the compression tank for heating the liquid hydrogen therein to a second temperature and a second pressure, the second temperature and pressure being higher than the first temperature and pressure so that the liquid hydrogen is converted to gaseous hydrogen; and
a closable line connected to the gaseous hydrogen outlet and extending therefrom, the closable line being in fluid communication with a receiving tank when the line is opened so that the gaseous hydrogen flows from the compresion tank to the receiving tank.

2. The apparatus, according to claim 1, in which the liquid hydrogen inlet is connected to a filling tank.

3. The apparatus, according to claim 2, in which a valve is located in series between the filling tank and the compression tank.

4. The apparatus, according to claim 1, in which the closable line includes a pre-heater located in series between the gaseous hydrogen outlet and a receiver tank connector.

5. The apparatus, according to claim 4, in which the first and second valves are located on either side of the pre-heater.

6. The apparatus, according to claim 5, in which a vent is located in series between the first valve and the gaseous hydrogen outlet.

7. The apparatus, according to claim 1, in which the receiving tank is located inside an unmanned aircraft.

8. The apparatus, according to claim 1, in which the gaseous hydrogen outlet is connected to a receiving tank, an amount of the heated, liquid gaseous hydrogen being dispensed from the compression tank to the receiving tank.
